(19) United States
(12) Patent Application Publication
(10) Pub. No.: US 2025/0206549 A1
(43) Pub. Date: Jun. 26, 2025

(54) System and Method for Uninterrupted Flow Stacking With Mobile Conveyors

(71) Applicant: Jacob Andrew Liss, San Diego, CA (US)

(72) Inventor: Jacob Andrew Liss, San Diego, CA (US)

(21) Appl. No.: 18/966,936

(22) Filed: Dec. 3, 2024

Related U.S. Application Data
(63) Continuation of application No. 17/943,976, filed on Sep. 13, 2022, now Pat. No. 12,157,645.
Application No. 17/943,976 is a continuation of application No. 63/360,065, filed on Sep. 2, 2021.

(51) Int. Cl. B65G 65/28; B65G 37/00; B65G 41/00

(52) U.S. Cl. CPC B65G 65/28; B65G 37/005; B65G 41/008

(57) ABSTRACT

A material handling methodology for forming cells of material includes a series of mobile telescoping conveyors feeding a mobile bridge conveyor and mobile radial stacker using a set of mobile bridge transfer conveyors. The method involves transferring material from an infeed point to a cell area in a systematic manner that allows for stacking each cell continuously with no interruption to material flow.

### RELATED APPLICATION

This application is a continuation, and claims the benefit of priority to U.S. patent application Ser. No. 17/943,976 for “System and Method for Uninterrupted Flow Stacking with Mobil Conveyors” filed Sep. 13, 2022, and currently co-pending, which in turn claims priority to U.S. Provisional Patent Application Ser. No. 63/360,065 for “Method for Uninterrupted Flow Stacking with Mobile Conveyors,” filed Sep. 2, 2021, the entirety of which is incorporated herein by reference.

### FIELD OF THE INVENTION

The present invention relates to bulk material conveying, specifically the components and methods that are used to stack bulk materials such as aggregates, ores, reclaimed ores, waste materials and any other conveyable bulk material.

### BACKGROUND OF THE INVENTION

Where storage is required for large amounts of bulk material, various methods exist in the prior art to place said material over areas of arbitrary size in a process known as stacking. A stack of arbitrary area and constant height is constructed from smaller volumes known as cells. Cells are created by moving the terminal discharge point of a material handling system along a continuous path over time. Stacking is achieved by combining two or more cells.

The economic viability of a particular stacking system is driven by the operational efficiency of the system's conveyor arrangement. Efficiency of the system is driven by the amount of operational down time—where material is not flowing—caused by the rearrangement required in the system to continue creating a cell or to move to start a new cell. Various methods exist in the prior art to minimize the amount and duration of material flow interruption during the stacking process.

### SUMMARY OF THE INVENTION

Provided is a material handling system that offers a method for stacking wherein there is no interruption to material flow during the creation of a cell and no material spillage is created. The preferred embodiment of the present invention utilizes a mobile radial stacker conveyor, mobile bridge conveyor, two (2) mobile bridge transfer conveyors, and a minimum of two (2) articulating mobile conveyors, all of which are self-propelled via slewing crawler tracks. Each articulating mobile conveyor is equipped with a discharge chute that can feed one of two downstream conveyors-another articulating mobile conveyor (primary feed) or a bridge transfer conveyor (transfer feed).

By using two mobile bridge transfer conveyors, material flow can be diverted from the first mobile bridge transfer conveyor to the second mobile bridge transfer conveyor while repositioning the first mobile bridge transfer conveyor. When the first mobile bridge transfer conveyor is repositioned, material flow can be directed through it again, allowing the second mobile bridge transfer conveyor to be moved. This allows for material flow to continue uninterrupted during stacking of the entirety of the cell, even as articulating mobile conveyors are removed.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the preferred embodiment positioned to initiate the stacking of the first segment of the first cell;

FIG. 2 is a perspective view of the preferred embodiment initiating the stacking of the first segment of the first cell;

FIG. 3 is a perspective view of the preferred embodiment having completed the stacking of the first segment of the first cell;

FIG. 4 is an elevation view of the mobile telescoping conveyor arrangements contemplated by the preferred embodiment;

FIG. 5 is a perspective view of the preferred embodiment during the first bridge transfer conveyor relocation;

FIG. 6 is a perspective view of the preferred embodiment during the second bridge transfer conveyor relocation;

FIG. 7 is a perspective view of the preferred embodiment upon the completion of the second segment of the first cell;

FIG. 8 is a perspective view of the preferred embodiment upon the completion of the third segment of the first cell;

FIG. 9 is a perspective view of the preferred embodiment upon the completion of the fourth segment of the first cell;

FIG. 10 is a perspective view of the preferred embodiment upon the completion of the fifth and final segment of the first cell;

FIG. 11 is a perspective view of the preferred embodiment in position to commence stacking of the second cell;

FIG. 12 is a perspective view of the preferred embodiment in position to commence stacking of the second cell, illustrating a preferred embodiment of the system infeed provided by another mobile conveying system;

FIG. 13 is a perspective view of the preferred embodiment in position to commence stacking of the second cell, illustrating an alternate preferred embodiment of the system infeed provided by a tripper conveyor;

FIG. 14 is a side view of a cell forming a substrate for a cell above it; and

FIG. 15 is a flowchart illustrating a preferred embodiment of a method for uninterrupted flow stacking with mobile conveyors.

### DETAILED DESCRIPTION

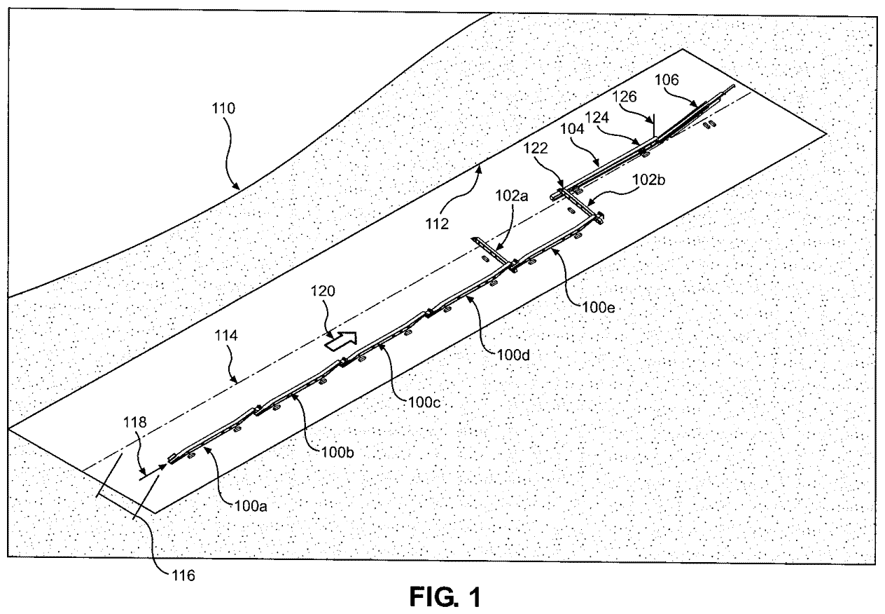

In FIG. 1 the preferred embodiment is shown in a stacking area 110 to initiate the stacking of a cell in a cell area 112 along a centerline 114. This arrangement contemplates a set of mobile telescoping conveyors 100a, 100b, 100c, 100d, 100e that are aligned parallel to the centerline 114 and offset by a length 116 defined by the geometry of the mobile bridge transfer conveyors 102a, 102b. Each mobile telescoping conveyor 100 is capable of discharging material to two points that may be occupied by other mobile conveyors such as a bridge transfer conveyor 102 or another articulating conveyor 100 as contemplated in the preferred embodiment. Initially, material flows from the system infeed point 118 via all telescoping conveyors 100 in the direction noted by flow arrow 120 to the bridge transfer conveyor 102b which feeds the mobile bridge conveyor 104. The bridge conveyor 104 may be fed at any point between the aft load limit area 122 and the fore load limit area 124. In the initial configuration in the bridge conveyor 104 is fed at the aft load limit area 122 via the active bridge transfer conveyor 102b. The material subsequently feeds the radial stacker conveyor 106 which in the preferred embodiment is affixed to the bridge conveyor 104 via a pinned connection with axis 126 at the material transfer point. The second bridge transfer conveyor 102b is positioned at the head end of the penultimate telescoping conveyor 100d, parallel to the first bridge transfer conveyor 102a.

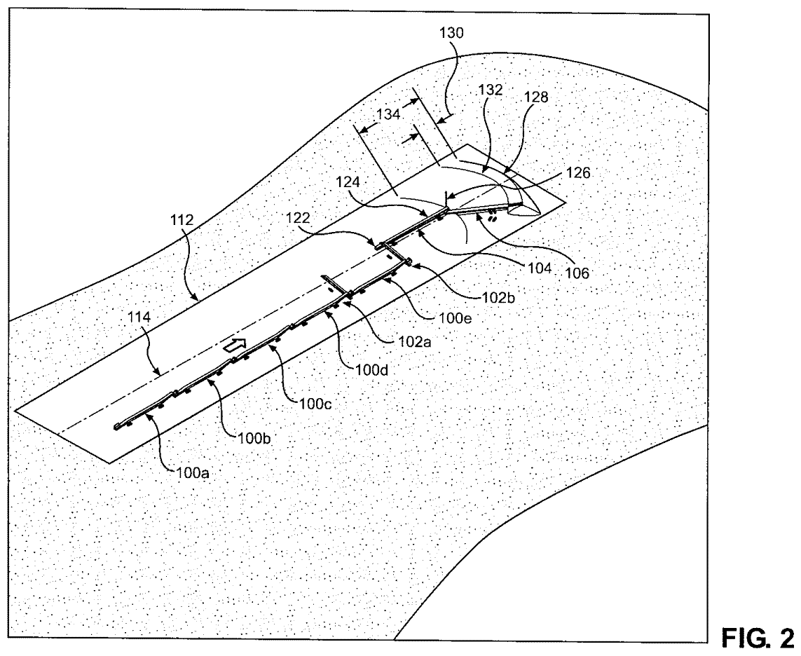

For the preferred embodiment, as shown in FIG. 2, the stacking of the cell area 112 begins with the radial stacker conveyor 106 depositing an arc of material 128 as it rotates about a pinned connection with axis 126. Upon completion of an arc 128 the radial stacker 106 and mobile bridge conveyor 104 retreat a distance 130 along the cell centerline 114 and create a subsequent arc 132. Upon completion of a certain quantity of material arcs such that the radial stacker conveyor 106 has retreated a distance 134, the fore load limit area 124 of the bridge conveyor 104 will reach the transfer point of the active bridge transfer conveyor 102b. Simultaneously, the aft load limit area 122 of the bridge conveyor 104 will align with the discharge of the inactive bridge transfer conveyor 102a. Throughout this phase of operation all mobile conveyors 100a, 100b, 100c, 100d, 100e, 102a, 102b remain stationary with the exception of the bridge conveyor 104 and the stacker conveyor 106.

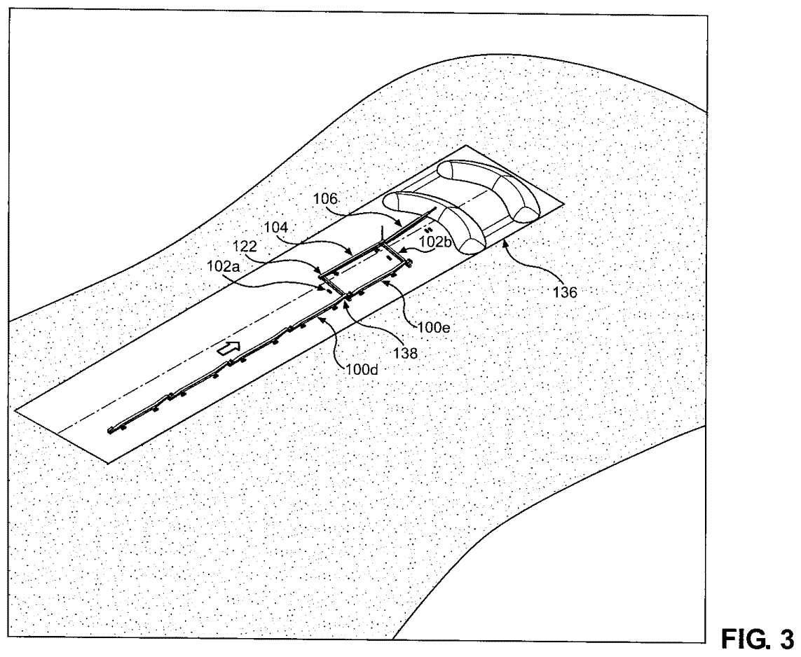

FIG. 3 shows the preferred embodiment upon completion of the first cell segment 136. The material flow is now diverted at the head end 138 of the penultimate telescoping conveyor 100d. Diverting the discharge of telescoping conveyor 100d has the effect of changing the material flow from the final telescoping conveyor 100e to the inactive bridge transfer conveyor 102a, such that it is now the active bridge transfer conveyor and bridge transfer conveyor 102b is now inactive. Material flow now reaches the bridge conveyor 104 at the maximum aft loading area 122.

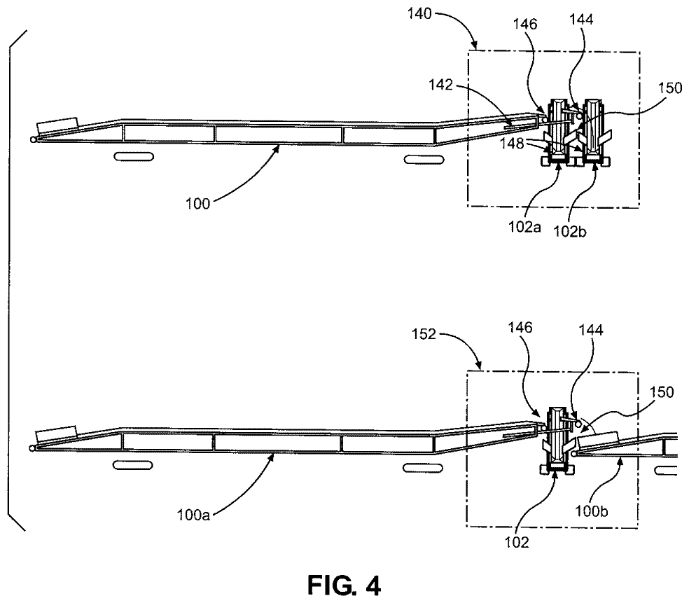

FIG. 4 shows elevation views of the discharge configurations contemplated for the mobile telescoping conveyors 100 of the preferred embodiment. Contemplated in one arrangement 140 is a push button activated hydraulic ram 142 which extends 144 and retracts 146 the material loading point 148 between the bridge transfer conveyors 102a, 102b, with a spillage guard 150. The preferred embodiment also contemplates a second arrangement 152 such that the retracted discharge 146 of the telescoping conveyor 100a feeds a bridge transfer conveyor 102 and the extended discharge 144 feeds another telescoping conveyor 100b.

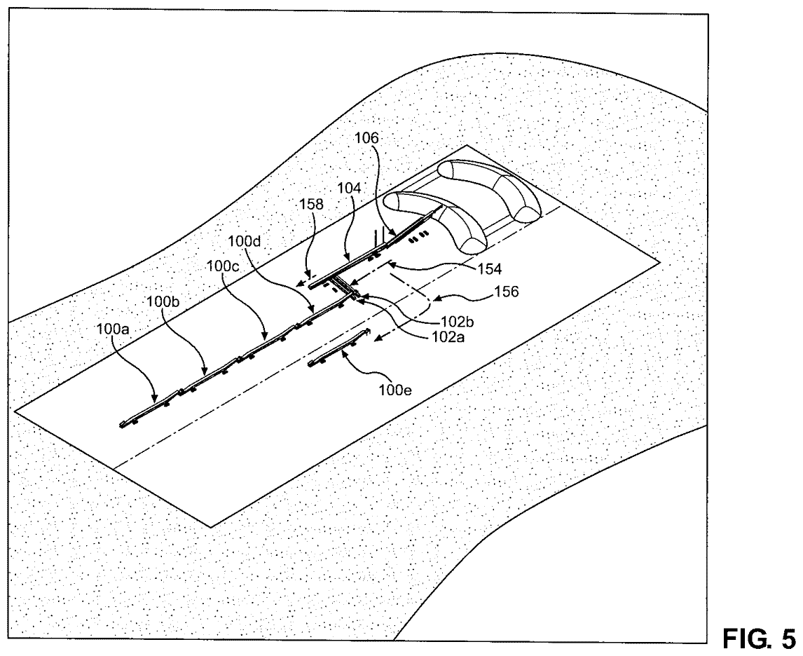

FIG. 5 shows a perspective view of the first bridge transfer maneuver, which occurs after bridge transfer conveyor 102b and telescoping conveyor 100e were deactivated by retracting the telescoping discharge of telescoping conveyor 100d. Bridge transfer conveyor 102b and telescoping conveyor 100e are moved as noted with path lines 154, 156. During this operation the bridge conveyor 104 and stacker conveyor 106 continue to stack material and retreat as noted by path line 158, fed by bridge transfer conveyor 102a and the remaining telescoping conveyors 100a, 100b, 100c, 100d. When the repositioned bridge transfer conveyor 102b is in position next to the active bridge transfer conveyor 102a the system is ready for the second bridge transfer maneuver.

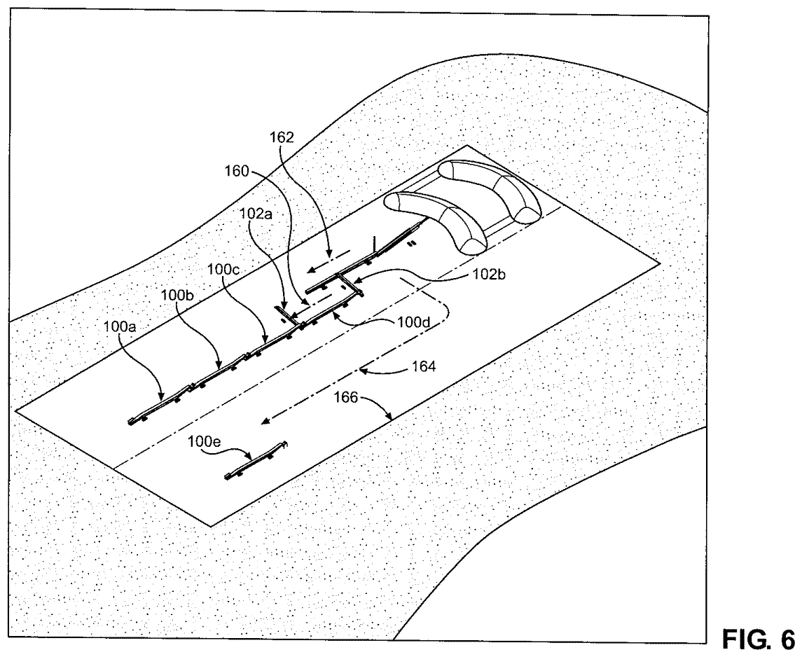

FIG. 6 shows a perspective view of the second bridge transfer maneuver, in which bridge transfer conveyor 102a is repositioned. Prior to moving bridge transfer conveyor 102a it must be deactivated, which is accomplished by extending the telescoping conveyor 100d to feed the newly repositioned bridge transfer conveyor 102b. With flow now diverted, bridge transfer conveyor 102a moves as noted by the path line 160 to the next required position. During this operation the bridge conveyor 104 and stacker conveyor 106 continue to stack material and retreat as noted by the path line 162, fed by bridge transfer conveyor 102b and the telescoping conveyors 100a, 100b, 100c, 100d. Telescoping conveyor 100e has completed transit via the noted path 164 and is positioned in the second cell area 166.

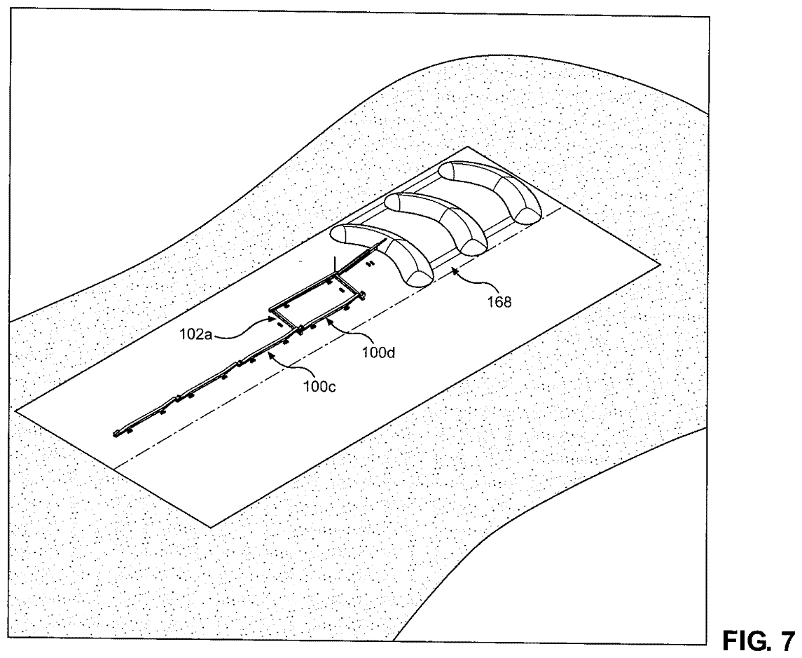

FIG. 7 shows a perspective view of the preferred embodiment having completed the stacking of the second cell segment 168. The system is in position for the diversion of the material flow from telescoping conveyor 100d to bridge transfer conveyor 102a at the head end of telescoping conveyor 100c. From this point forward additional cell segments are created using an identical sequence of flow changes and mobile conveyor movements.

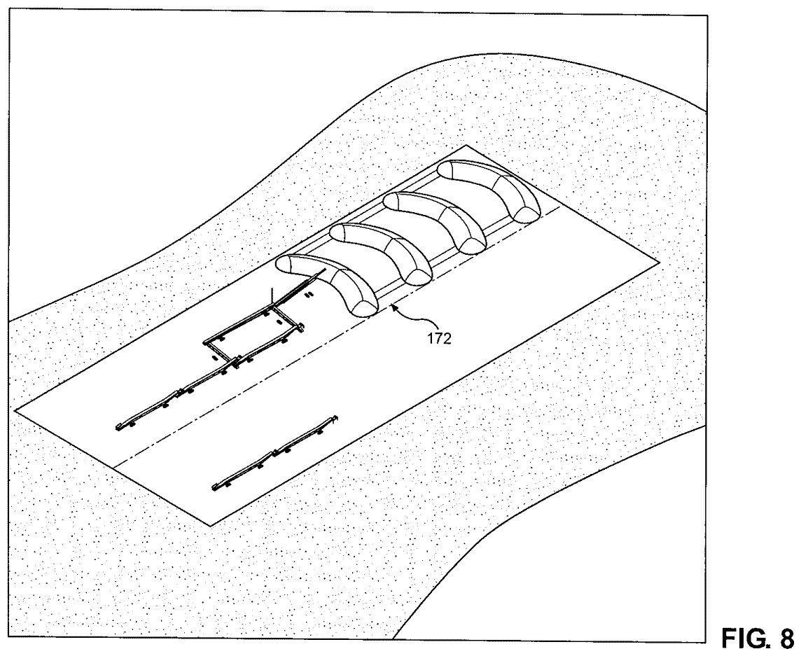

FIG. 8 shows a perspective view of the preferred embodiment having completed the stacking of the third cell segment 172.

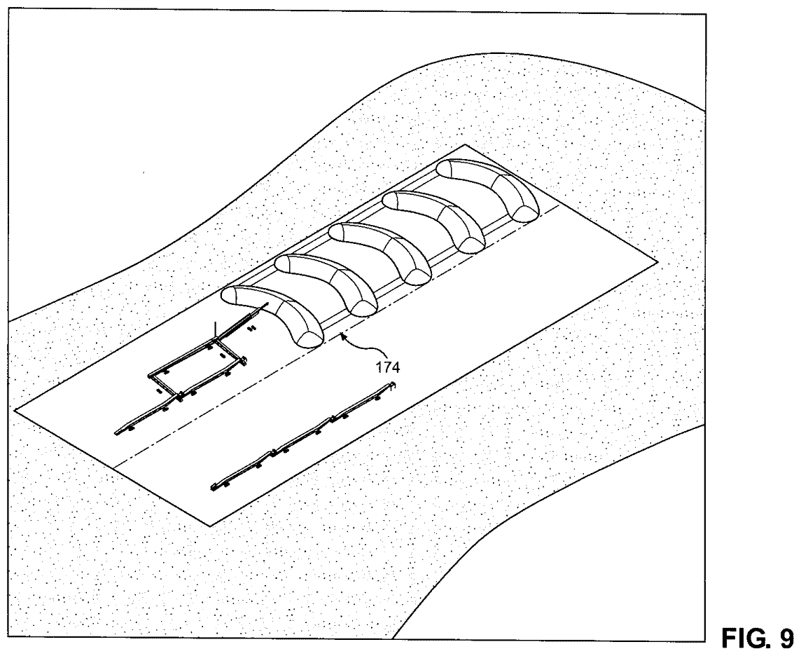

FIG. 9 shows a perspective view of the preferred embodiment having completed the stacking of the fourth cell segment 174.

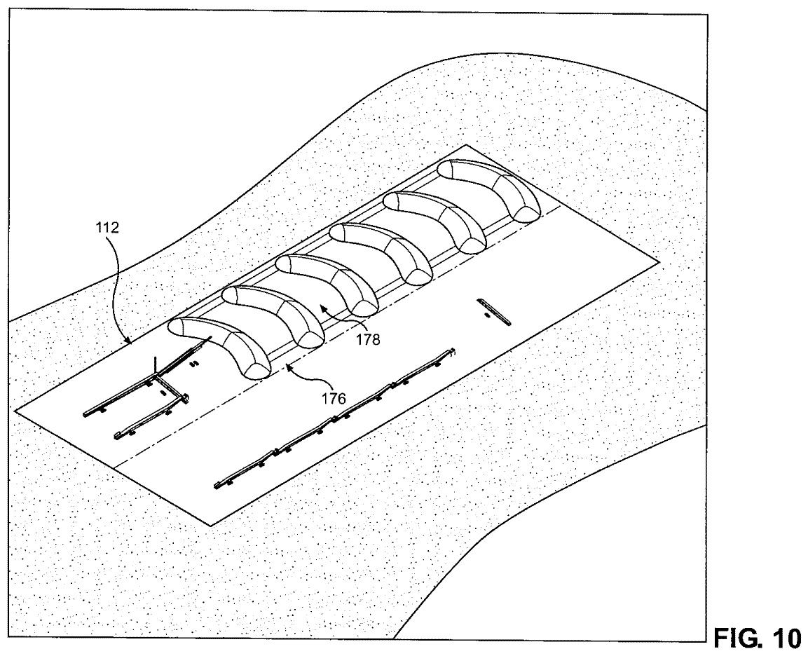

FIG. 10 shows a perspective view of the preferred embodiment having completed the stacking of the fifth cell segment 176 which completes the stacking of the cell 178 for this cell area 112. As illustrated, when enough cell segments are stacked so that only a single mobile telescoping conveyor 100a remains in the first cell area 112, mobile bridge transfer conveyor 102a is positioned in the second cell area 166 in preparation for commencing stacking of another cell.

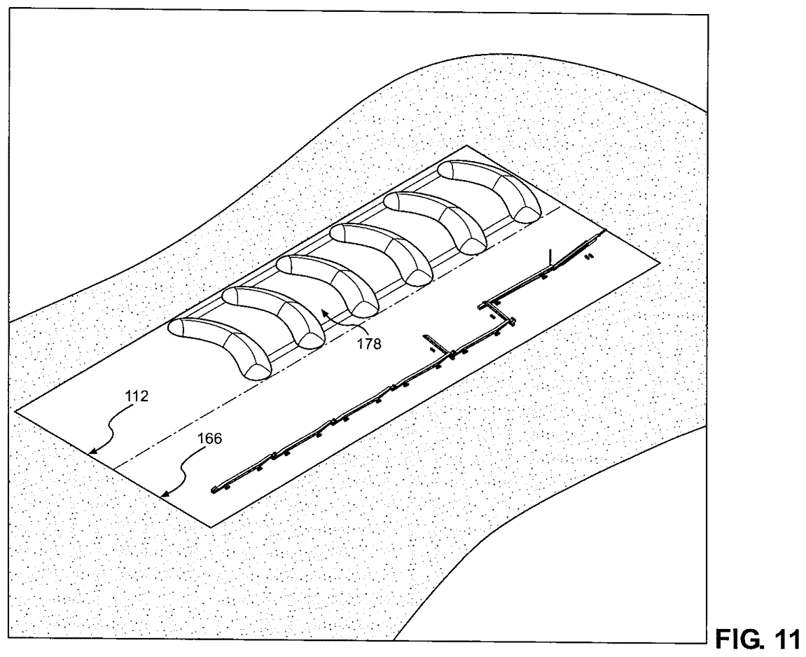

FIG. 11 shows a perspective view of the preferred embodiment in position to commence stacking a cell in the second cell area 166, having completed stacking the cell 178 in the first cell area 112. Mobile bridge transfer conveyor 102b, bridge conveyor 104, and radial stacker conveyor 106 are positioned in the second cell area 166 in order to repeat the process to stack another cell. As illustrated, in a preferred embodiment mobile bridge transfer conveyor 102a is positioned at the head of the last telescoping conveyor 100 while mobile bridge transfer conveyor 102b is positioned at the head of the penultimate telescoping conveyor 100 in the second cell area 166.

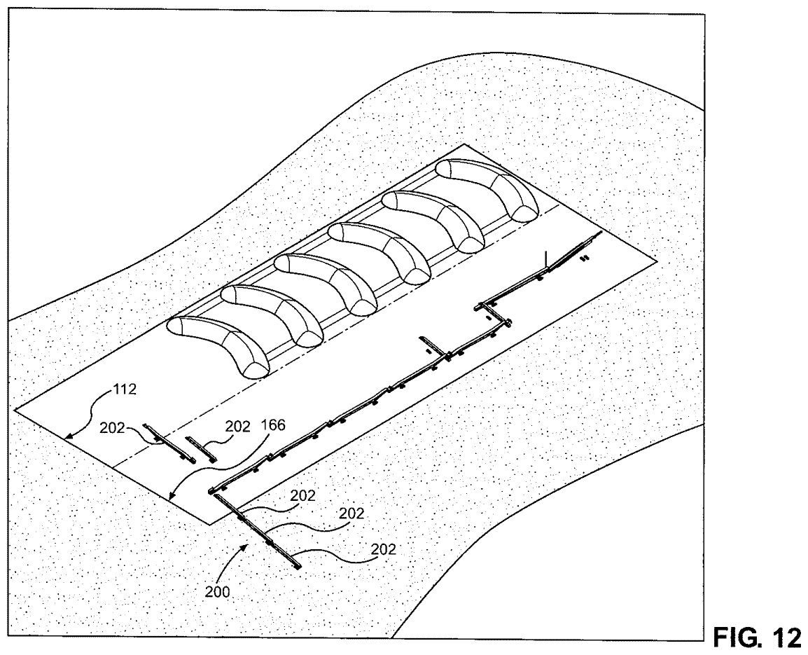

Referring now to FIG. 12, in a preferred embodiment system infeed 200 is provided by another mobile conveying system made up of conveyors 202. In an exemplary embodiment, conveyors 202 are added or removed from system 200 as needed in order to commence stacking in a new cell from any arbitrary infeed location.

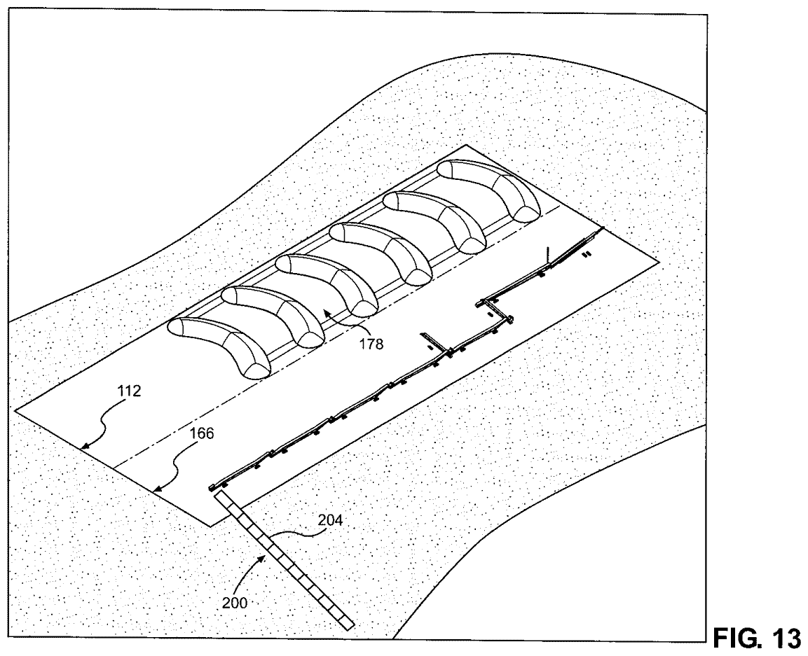

Referring now to FIG. 13, in alternate embodiments system infeed 200 is provided by another infeed system, such as a tripper conveyor 204 operating on a fixed overland conveyor (not illustrated in FIG. 13). Either a fixed tripper conveyor or a mobile tripper conveyor can be used as desired and according to site requirements.

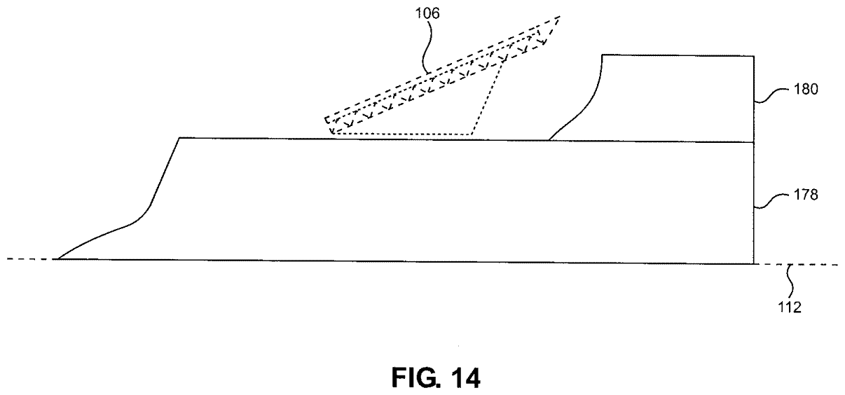

Referring now to FIG. 14, in some embodiments, a completed cell 178 is used as a substrate for a cell 180 or more than one cell 180 above it.

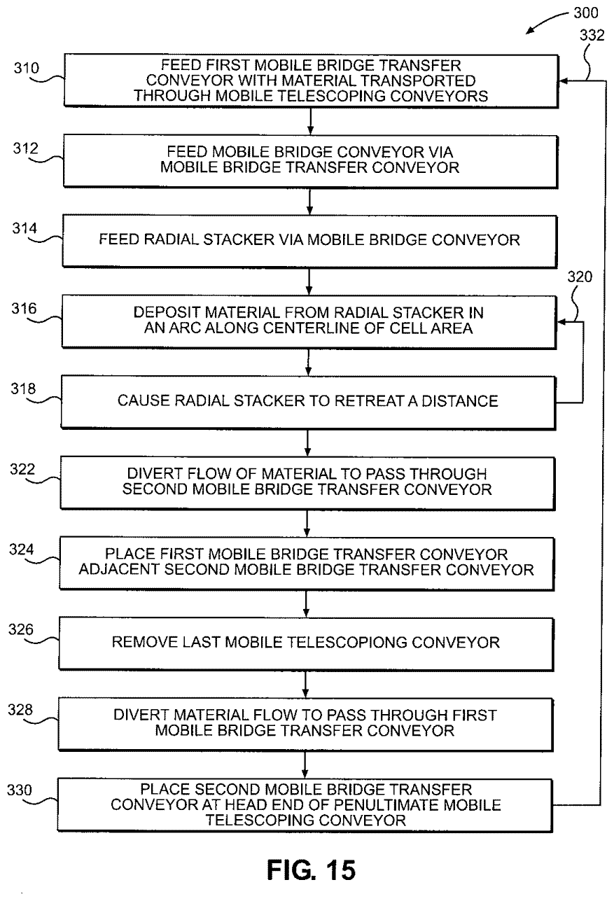

Referring now to FIG. 15, a preferred embodiment of a method for uninterrupted flow stacking with mobile conveyors is illustrated and generally designated 300. Method 300 operates via an uninterrupted flow stacking system with mobile conveyors such as the embodiment of a flow stacking system illustrated in FIGS. 1-13, and includes steps 310, 312, and 314 of feeding material to be stacked. More particularly, in step 310, material is fed through the mobile telescoping conveyors 100 to mobile bridge transfer conveyor 102b, or, during a bridge transfer maneuver, mobile bridge transfer conveyor 102a (see FIGS. 1-3). In step 312, the material is transferred through mobile bridge transfer conveyor 102b or mobile bridge transfer conveyor 102a to mobile bridge conveyor 104. In step 314, the material is transferred through mobile bridge conveyor 104 to radial stacker conveyor 106, which deposits the material in an arc along centerline 114 of cell area 112. Steps 310, 312, 314, and 316 are performed continuously throughout method 300, since method 300 enables uninterrupted flow stacking.

Radial stacker conveyor 106 deposits material in step 316 and retreats a distance in step 318 once an arc is completed in order to continue depositing material in a subsequent arc. Steps 316 and 318 are performed continuously by the radial stacker conveyor 106 throughout method 300 as indicated by loop path 320.

When the radial stacker conveyor 106 has retreated sufficiently that the aft load limit area of mobile bridge conveyor 104 aligns with mobile bridge transfer conveyor 102a, step 322 is performed in which the flow of material is diverted so that it passes through mobile bridge transfer conveyor 102a rather than mobile bridge transfer conveyor 102b in order to feed mobile bridge conveyor 104 and radial stacker conveyor 106. Once step 322 is performed, the system is ready for the first bridge transfer maneuver, which involves steps 324 and 326. In step 324, the deactivated mobile bridge transfer conveyor 102b is moved and placed adjacent the active mobile bridge transfer conveyor 102a. In step 326, the last mobile telescoping conveyor 100 is removed; in this step, the removed mobile telescoping conveyor 100 is generally positioned in another cell area in preparation for stacking another cell once stacking of the current cell is completed.

After the first bridge transfer maneuver is completed, step 328 is performed in preparation for the second bridge transfer maneuver. In step 328, mobile bridge transfer conveyor 102b once again becomes the active mobile bridge transfer conveyor: Material flow is diverted to pass through mobile bridge transfer conveyor 102b rather than mobile bridge transfer conveyor 102a in order to feed mobile bridge conveyor 104 and radial stacker conveyor 106. The second bridge transfer maneuver is then performed as illustrated by step 330 of placing the second mobile bridge transfer conveyor 102a at the head of the penultimate mobile telescoping conveyor 100 (which was the antepenultimate mobile telescoping conveyor prior to removal of a mobile telescoping conveyor in step 326).

As indicated by loop path 332, the steps of method 300 are repeated until a cell 178 (see FIG. 10) is completely stacked.

While there have been shown what are presently considered to be preferred embodiments of the present invention, it will be apparent to those skilled in the art that various changes and modifications can be made herein without departing from the scope and spirit of the invention.

1. A system for uninterrupted flow stacking, comprising:
a first cell area;
a mobile radial stacker;
a mobile bridge conveyor having a fore load limit area and an aft load limit area;
a plurality of mobile telescoping conveyors for a plurality material to travel down;
a first mobile bridge transfer conveyor having a first flow output to deposit the plurality of material into the first cell area;
a second mobile bridge transfer conveyor having a second flow output to deposit the plurality of material into the first cell area;
a first discharge configuration in which the first cell area is filled by the first flow output of the first mobile bridge transfer conveyor; and
a second discharge configuration in which the first cell area is filled by the second flow output of the second mobile bridge transfer conveyor, and
wherein the system is configured to alternate between the first discharge configuration and the second discharge configuration until the first cell area is filled with the plurality of material.
